(19) United States
(12) Patent Application Publication
(10) Pub. No.: US 2024/0245036 A1
(43) Pub. Date: Jul. 25, 2024

(54) PET WASTE BAGS AND USES THEREOF

(71) Applicant: Petros Fessahaye HAGOS, La Mesa, CA (US)

(72) Inventor: Petros Fessahaye HAGOS, La Mesa, CA (US)

(21) Appl. No.: 18/416,707

(22) Filed: Jan. 18, 2024

Related U.S. Application Data
(60) Provisional application No. 63/440,346, filed on Jan. 20, 2023.

(51) Int. Cl. A01K 23/00

(52) U.S. Cl. CPC A01K 23/005

(57) ABSTRACT

The present disclosure provides pet waste bags that are useful for collecting and securing pet waste, such as from a dog, as well as packages and kits of the same, and methods of manufacturing and using the same.

### FIELD

The present disclosure relates to pet waste bags, and methods of manufacturing and using the same.

### BACKGROUND

Pets frequently need to release waste—such as while being taken on a walk or while on the owner's own property. This typically requires the owner to pick up the waste, especially when the waste is left somewhere other than on the owner's property.

Some waste bags used for collecting waste are not ideal because, for instance, (1) they require the user to identify which end includes the opening, (2) they require extra effort to peel open the bag due to a lack of friction between the user's hand and the smooth plastic waste bag, and (3) they require the user to excessively handle the bag containing the waste by tieing the waste bag closed, which could also result in the undesirable smelling of the waste. Moreover, failure to securely close a waste bag and/or for it to remain securely closed, e.g., airtight or substantially airtight, can result in an undesirable odor as the user carries the waste.

For at least these reasons, there is a need among consumers for a waste bag that (1) allows for easily identifying the end that includes the opening, (2) is easy to peel open, (3) is easy to seal closed, and (4) is securely closed to lock in the waste and the undesirable odor.

### SUMMARY

Provided herein are pet waste bags, and methods of manufacturing and using the same.

Specifically, provided herein is a pet waste bag, comprising: a body portion comprising an open end and a closed end; and a fastener connected to the body portion. In some embodiments, the fastener is connected to the body portion by an adhesive or by an adhesive tape comprising an adhesive. In some embodiments, the fastener is connected to the body portion by an adhesive. In some embodiments, the adhesive is or comprises a non-metallic substance that directly binds the fastener to the body portion. In some embodiments, the fastener is connected to the body portion by an adhesive tape comprising an adhesive. In some embodiments, the adhesive tape secures the fastener to the body portion.

In some of any of such embodiments, the adhesive tape comprises a non-metallic substance that directly binds the adhesive tape to the fastener and the body portion. In some of any of such embodiments, the adhesive is or comprises an acrylic-based adhesive, a silicone-based adhesive, or a rubber-based adhesive. In some of any of such embodiments, the adhesive is or comprises a cyanoacrylate adhesive. In some of any of such embodiments, the adhesive tape comprises an acrylic-based adhesive, a silicone-based adhesive, or a rubber-based adhesive. In some embodiments, the adhesive tape comprises a rubber-based adhesive. In some of any of such embodiments, the adhesive tape comprises a vinyl backing and a rubber-based adhesive. In some embodiments, the vinyl backing is a polyvinyl chloride (PVC) backing. In some of any of such embodiments, the adhesive tape comprises an acrylic-based adhesive. In some of any of such embodiments, the adhesive tape comprises an acrylic-based adhesive and a backing selected from the group consisting of a polyester backing, a polyethylene backing, a polyurethane backing, a polytetrafluoroethylene backing, and a nylon backing. In some of any of such embodiments, the adhesive tape comprises an acrylic-based adhesive and a polyethylene backing.

In some of any of such embodiments, the fastener is a twist tie. In some embodiments, the twist tie comprises a wire. In some embodiments, the wire is encased within a paper material, a plastic material, a biodegradable material, or a compostable material. In some of any of such embodiments, the wire is encased within a paper material.

In some of any of such embodiments, the fastener is or comprises a wire. In some embodiments, the wire is not encased within a material. In some of any of such embodiments, the wire is not encased within a paper material or a plastic material. In some embodiments, the wire is encased within a paper material, a plastic material, a biodegradable material, or a compostable material.

In some of any of such embodiments, the fastener is connected to the body portion at a site that is less than 60% of the distance from the open end to the closed end. In some of any of such embodiments, the fastener is connected to the body portion at a site that is less than 55%, less than 50%, less than 45%, less than 40%, less than 35%, less than 30%, less than 25%, less than 20%, less than 15%, or less than 10% of the distance from the open end to the closed end. In some of any of such embodiments, the fastener is connected to the body portion at a site that is between or between about 5% and 60% of the distance from the open end to the closed end. In some of any of such embodiments, the fastener is connected to the body portion at a site that is between or between about 10% and 60%, between or between about 15% and 55%, between or between about 20% and 50%, between or between about 25% and 45%, between or between about 30% and 45%, between or between about 35% and 45% of the distance from the open end to the closed end. In some of any of such embodiments, the fastener is connected to the body portion at a site that is at or about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the distance from the open end to the closed end. In some of any of such embodiments, the fastener is connected to the body portion at a site that is at or about 40% or 41% of the distance from the open end to the closed end.

In some of any of such embodiments, the distance from the open end to the closed end is between or between about 4 inches and 20 inches. In some of any of such embodiments, the distance from the open end to the closed end is between or between about 4 inches and 20 inches, between or between about 5 inches and 18 inches, between or between about 6 inches and 16 inches, between or between about 8 inches and 16 inches, between or between about 10 inches and 16 inches, between or between about 12 inches and 16 inches, or between or between about 12 inches and 14 inches. In some of any of such embodiments, the distance from the open end to the closed end is at or about 5 inches, 5.5 inches, 6 inches, 6.5 inches, 7 inches, 7.5 inches, 8 inches, 8.5 inches, 9 inches, 9.5 inches, 10 inches, 10.5 inches, 11 inches, 11.5 inches, 12 inches, 12.5 inches, 13 inches, 13.5 inches, 14 inches, 14.5 inches, 15 inches, 15.5 inches, 16 inches, 16.5 inches, 17 inches, 17.5 inches, or 18 inches. In some of any of such embodiments, the distance from the open end to the closed end is at or about 13.5 inches.

In some of any of such embodiments, the fastener is connected to the body portion at a site that is between or between about 1 inch and 8 inches from the open end. In some of any of such embodiments, the fastener is connected to the body portion at a site that is between or between about 1 inch and 7.5 inches, between or between about 1.5 inch and 7 inches, between or between about 2 inches and 7 inches, between or between about 2.5 inches and 7 inches, between or between about 3 inches and 6.5 inches, between or between about 3.5 inches and 6.5 inches, between or between about 4 inches and 6.5 inches, between or between about 4 inches and 6 inches, between or between about 4.5 inches and 6 inches, or between or between about 5 inches and 6 inches from the open end. In some embodiments, the fastener is connected to the body portion at a site that is at or about 1 inch, 1.5 inches, 2 inches, 2.5 inches, 3 inches, 3.5 inches, 4 inches, 4.5 inches, 5 inches, 5.5 inches, 6 inches, 6.5 inches, 7 inches, 7.5 inches, or 8 inches from the open end. In some of any of such embodiments, the fastener is connected to the body portion at a site that is at or about 5.5 inches from the open end.

In some of any of such embodiments, the open end comprises a rim and the fastener is connected to the body portion at a site that is on or adjacent to the rim. In some of any of such embodiments, the fastener is connected to the body portion at a site that is no more than 0.5 inch, 1 inch, 1.5 inch, 2 inches, 2.5 inches, 3 inches, 3.5 inches, 4 inches, 4.5 inches, 5 inches, 5.5 inches, 6 inches, 6.5 inches, or 7 inches from the rim. In some embodiments, the distance from the open end to the closed end is between or between about 8 inches and 18 inches, between or between about 8 inches and 16 inches, between or between about 10 inches and 16 inches, between or between about 12 inches and 16 inches, or between or between about 12 inches and 14 inches.

In some of any of such embodiments, when the fastener is peeled off of the body portion, the fastener remains connected to the body portion by the adhesive or by the adhesive tape.

In some of any of such embodiments, the fastener is at least 0.5 inch, at least 0.75 inch, at least 1 inch, at least 1.25 inch, at least 1.5 inch, at least 1.75 inch, at least 2 inches, at least 2.25 inches, at least 2.5 inches, at least 2.75 inches, at least 3 inches, at least 3.25 inches, at least 3.5 inches, at least 3.75 inches, at least 4 inches, at least 4.25 inches, at least 4.5 inches, at least 4.75 inches, at least 5 inches, at least 5.25 inches, at least 5.5 inches, at least 5.75 inches, or at least 6 inches in length.

In some of any of such embodiments, the fastener is between or between about 1 inch and 6 inches, between or between about 2 inches and 5.5 inches, between or between about 2.5 inches and 5.5 inches, between or between about 3 inches and 5.5 inches, between or between about 3.5 inches and 5.5 inches, between or between about 3.5 inches and 5 inches, between or between about 3.5 inches and 5 inches, or between or between about 3.5 inches and 4.5 inches in length.

In some of any of such embodiments, the fastener comprises a portion that is directly fixed to the body portion by the adhesive or the adhesive tape and a portion that is not directly fixed to the body portion by the adhesive or the adhesive tape. In some embodiments, the portion that is directly fixed to the body portion by the adhesive or the adhesive tape is between or between about 0.5 inch and 5 inches, between or between about 1 inch and 5 inches, between or between about 1.5 inch and 5 inches, between or between about 2 inches and 5 inches, between or between about 0.5 inch and 4 inches, between or between about 1 inch and 4 inches, between or between about 1.5 inch and 4 inches, between or between about 2 inches and 4 inches, between or between about 0.5 inch and 3 inches, between or between about 1 inch and 3 inches, between or between about 1.5 inch and 3 inches, or between or between about 2 inches and 3 inches in length. In some of any of such embodiments, the portion that is directly fixed to the body portion by the adhesive or the adhesive tape is or is about 0.25 inch, 0.5 inch, 0.75 inch, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, or 4 inches in length. In some of any of such embodiments, the portion that is directly fixed to the body portion by the adhesive or the adhesive tape is between or between about 2 inches and 2.5 inches.

In some of any of such embodiments, when the portion of the fastener that is not directly fixed to the body portion by the adhesive or the adhesive tape is peeled off the body portion, the portion of the fastener that is directly fixed to the body portion by the adhesive or the adhesive tape remains connected to the body portion by the adhesive or by the adhesive tape.

In some of any of such embodiments, the pet waste bag further comprises a gripping texture.

Also provided herein is a pet waste bag, comprising: a body portion comprising an open end and a closed end; and a gripping texture. In some embodiments, the pet waste bag further comprises a fastener.

In some of any of such embodiments, the gripping texture comprises a raised texture. In some of any of such embodiments, the raised texture comprises one or more of raised dots, raised lines, ridges, raised shapes, or any combination thereof. In some embodiments, the raised texture comprises one or more of raised dots, raised lines, ridges, raised shapes, or any combination thereof, in one or more sizes.

In some of any of such embodiments, the gripping texture is located on or adjacent to the open end. In some of any of such embodiments, the open end comprises a rim and the gripping texture is located on or adjacent to the rim.

In some embodiments, the gripping texture is located on at least or at least about 10% of the perimeter of the rim. In some of any of such embodiments, the gripping texture is located on at least 10%, 20%, 30%, 40%, 50%, 60%, 70%, 80%, or 90% of the perimeter of the body portion. In some of any of such embodiments, the gripping texture is located on or on about 90%, 91%, 92%, 93%, 94%, 95%, 96%, 97%, 98%, 99%, or 100% of the perimeter of the body portion. In some of any of such embodiments, the gripping texture is located on between or between about 10% and 100%, between or between about 20% and 90%, between or between about 20% and 80%, between or between about 30% and 70%, between or between about 40% and 60%, between or between about 30% and 100%, between or between about 40% and 100%, between or between about 50% and 100%, between or between about 10% and 50%, between or between about 10% and 40%, between or between about 10% and 30%, between or between about 20% and 50%, between or between about 30% and 50%, or between or between about 40% and 50% of the perimeter of the body portion. In some of any of such embodiments, the gripping texture is located on or on about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53% 54%, or 55% of the perimeter of the body portion.

In some of any of such embodiments, the gripping texture extends for a length of between or between about 1 inch and 24 inches along the perimeter of the body portion. In some of any of such embodiments, the gripping texture extends for a length of between or between about 1 inch and 24 inches, between or between about 2 inches and 24 inches, between or between about 4 inches and 24 inches, between or between about 6 inches and 24 inches, between or between about 8 inches and 24 inches, between or between about 9 inches and 24 inches, between or between about 10 inches and 24 inches, between or between about 12 inches and 24 inches, between or between about 14 inches and 24 inches, between or between about 16 inches and 24 inches, between or between about 16 inches and 20 inches, between or between about 17 inches and 19 inches, between or between about 1 inch and 12 inches, between or between about 2 inches and 12 inches, between or between about 3 inches and 12 inches, between or between about 4 inches and 12 inches, between or between about 5 inches and 12 inches, between or between about 6 inches and 12 inches, between or between about 7 inches and 10 inches, between or between about 8 inches and 10 inches, between or between about 1 inch and 8 inches, between or between about 2 inches and 7 inches, between or between about 3 inches and 6 inches, or between or between about 4 inches and 5 inches along the perimeter of the body portion.

In some of any of such embodiments, the gripping texture is located 1 inch or less from the open end. In some of any of such embodiments, the gripping texture is located less than or less than about 0.9 inch, 0.8 inch, 0.7 inch, 0.6 inch, 0.5 inch, 0.4 inch, 0.3 inch, or 0.2 inch from the open end. In some of any of such embodiments, the gripping texture is located at or about 0.1 inch, 0.15 inch, 0.2 inch, 0.25 inch, 0.3 inch, 0.35 inch, or 0.4 inch from the open end. In some of any of such embodiments, the gripping texture has a width of between or between about 0.1 inch and 2 inches, wherein the width of the gripping texture is the width of the gripping texture in the direction from the open end to the closed end. In some of any of such embodiments, the gripping texture has a width of between or between about 0.1 inch and 1.8 inches, between or between about 0.1 inch and 1.6 inches, between or between about 0.1 inch and 1.4 inches, between or between about 0.1 inch and 1.2 inches, between or between about 0.1 inch and 1 inch, between or between about 0.25 inch and 2 inches, between or between about 0.25 inch and 1.8 inches, between or between about 0.25 inch and 1.6 inches, between or between about 0.25 inch and 1.4 inches, between or between about 0.25 inch and 1.2 inches, between or between about 0.25 inch and 1 inch, wherein the width of the gripping texture is the width of the gripping texture in the direction from the open end to the closed end. In some of any of such embodiments, the gripping texture has a width of at or about 0.2 inch, 0.25 inch, 0.3 inch, 0.35 inch, 0.4 inch, 0.45 inch, 0.5 inch, 0.55 inch, 0.6 inch, 0.65 inch, 0.7 inch, 0.75 inch, 0.8 inch, 0.85 inch, 0.9 inch, 0.95 inch, 1 inch, 1.05 inches, 1.1 inches, 1.15 inches, 1.2 inches, or 1.25 inches, wherein the width of the gripping texture is the width of the gripping texture in the direction from the open end to the closed end.

In some of any of such embodiments, the body portion comprises plastic. In some embodiments, the plastic is selected from the group consisting of high-density polyethylene (HDPE), low-density polyethylene (LDPE), and linear low-density polyethylene (LLDPE). In some of any of such embodiments, the body portion of the pet waste bag comprises HDPE.

In some of any of such embodiments, the body portion comprises a biodegradable material or a compostable material. In some of any of such embodiments, the body portion comprises a biodegradable material. In some of any of such embodiments, the biodegradable material is a biodegradable plastic material. In some of any of such embodiments, the biodegradable material comprises one or more of a cellulose-based material, a starch-based material, a lignin-based material, a soy-based material, a polyactic acid-based material, or a paper-based material.

Also provided herein is a package of pet waste bags, comprising two or more of any of the pet waste bags disclosed herein. In some embodiments, the two or more of the pet waste bag is, is about, is at least, or is at least about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 125, 150, 175, 200, 225, or 250 of any of the pet waste bag disclosed herein. In some of any of such embodiments, the two or more pet waste bags are linked together. In some of any of such embodiments, each of the two or more pet waste bags is linked to another of the two or more pet waste bags by a perforated edge that separates the open end of one bag from the closed end of another bag. In some embodiments, for each of the two or more pet waste bags, the perforated edge is located on the open end and/or the closed end of the body portion.

Also provided herein is a pet waste collection kit, comprising: any pet waste bag disclosed herein; and a pet waste scooping device. In some embodiments, the kit further comprises instructions for use.

Also provided herein is a pet waste collection kit, comprising: a package of any pet waste bag disclosed herein; and a pet waste scooping device. In some embodiments, the kit further comprises instructions for use.

Also provided herein is a method of manufacturing a pet waste bag, comprising: obtaining a body portion comprising an open end and a closed end; and connecting a fastener to the body portion. In some embodiments, the fastener is connected to the body portion by an adhesive. In some embodiments, the fastener is connected to the body portion by an adhesive tape comprising an adhesive.

In some of any of such embodiments, the fastener is connected to the body portion at a location that is within 7 inches from the open end of the body portion.

In some of any of such embodiments, the fastener is a twist tie. In some embodiments, the twist tie comprises a wire.

In some of any of such embodiments, the fastener is or comprises a wire.

In some of any of such embodiments, the wire is encased within a paper material, a plastic material, a biodegradable material, or a compostable material. In some of any of such embodiments, the wire is encased within a paper material.

In some of any of such embodiments, the fastener is a wire.

In some of any of such embodiments, the wire is not encased within a material.

In some of any of such embodiments, the method further comprises applying a gripping texture to the body portion.

Also provided herein is a method of manufacturing a pet waste bag, comprising: obtaining a body portion comprising an open end and a closed end; and applying a gripping texture to the body portion. In some of any of such embodiments, the gripping texture is applied to the body portion at a location that is within or within about 2 inches from the open end of the body portion.

Also provided herein is a method of using a pet waste bag, comprising: obtaining any pet waste bag comprising a fastener that is disclosed herein; securing pet waste inside of the pet waste bag; and sealing the pet waste bag closed using the fastener. In some embodiments, the method further comprises peeling open the open end of the pet waste bag using the gripping texture. In some of any of such embodiments, the method further comprises twisting the body portion of the pet waste bag into a closed configuration or a substantially closed configuration prior to sealing the pet waste bag closed using the fastener. In some of any of such embodiments, sealing the pet waste bag closed using the fastener comprises wrapping the fastener around the body portion of the pet waste bag one or more times at or near the location where the body portion was twisted. In some of any of such embodiments, sealing the pet waste bag closed using the fastener comprises wrapping the fastener around the body portion of the pet waste bag one or more times. In some of any of such embodiments, the sealing results in an airtight or substantially airtight seal around the pet waste.

Also provided herein is a method of using a pet waste bag, comprising: obtaining any pet waste bag comprising a gripping texture that is disclosed herein; peeling open the open end of the pet waste bag using the gripping texture; securing pet waste inside of the pet waste bag; and closing the pet waste bag.

### BRIEF DESCRIPTION OF THE DRAWINGS

FIG. 1A-1D depicts exemplary embodiments and configurations for a pet waste bag 100. FIG. 1A depicts an exemplary pet waste bag 115 comprising a body portion 108 comprising an open end 101, a closed end 102, a fastener 103 situated along the open end, a gripping texture 104 situated along the open end, and an adhesive 105 that connects the fastener 103 to the body portion such that the fastener remains attached to the body portion after being fully peeled. FIG. 1B depicts an exemplary pet waste bag 100 comprising a body portion comprising an open end 101, a closed end 102, a fastener 103 situated along the open end, a gripping texture 104 situated along the open end, and an adhesive 105 that connects the fastener 103 to the body portion, which is depicted in an opened configuration that is ready to receive waste. The exemplary pet waste bag depicted in FIG. 1B comprises a round closed end 102. FIG. 1C depicts an exemplary pet waste bag 100 after the bag has collected the pet waste 106 and the fastener 103 has been used to seal closed the open end of the pet waste bag. In this embodiment depicted in FIG. 1C, the fastener, which in this embodiment is a twist tie, after being fully peeled, was wrapped around the closed end multiple times in order to seal the pet waste bag closed in an air-tight manner, which allowed for the quick and easy sealing of the pet waste bag without the need for tieing the bag closed using the body portion itself for the tieing, which can involve a large amount of undesirable handling of the bag containing the smelly waste. FIG. 1D depicts an exemplary embodiment of three pet waste bags linked to one another in a sequence and separated by a perforated edge 107 on the open and closed end of each pet waste bag (except for the pet waste bag on each end of the linked set of pet waste bags), which allows for easy separation of each individual bag for use.

FIGS. 2A and 2B depict an exemplary embodiment of a pet waste bag 100 as viewed from the front (FIG. 2A) and as viewed from the back (FIG. 2B). The exemplary embodiment of the pet waste bag shown in FIGS. 2A and 2B includes a gripping texture 104 at the open end.

FIG. 3 depicts an exemplary embodiment of a pet waste bag 100 as viewed from two different perspectives: a perspective from above the pet waste bag (FIG. 3, left) to depict the open configuration of the open end 101, and a perspective from below the pet waste bag (FIG. 3, right) to depict the gusseted configuration on the closed end 102.

FIGS. 4A-4D depict an exemplary embodiment of a pet waste bag 100 from an inverted front (FIGS. 4A and 4C) perspective and from an inverted back (FIGS. 4B and 4D) perspective, in which the pet waste bag is turned inside out. In this embodiment, the fastener 103 is a twist tie that is connected to the body portion by an adhesive tape 109 in the interior of the body portion of the pet waste bag. Once the pet waste bag is inverted, as shown in FIGS. 4A and 4B, the fastener (e.g., twist tie) is accessible and can be peeled away from the body portion so that it is extended to full length, as shown in FIGS. 4C and 4D, which can then be used to seal the body portion of the pet waste bag by wrapping the fastener (e.g., twist tie) around the body portion one or more times. FIGS. 4A and 4B depict the exemplary pet waste bag with the fastener prior to being peeled away from the body portion, and FIGS. 4C and 4D depict the exemplary pet waste bag with the exemplary fastener (a twist tie) after it is peeled away from the body portion and is extended out from the body portion.

### DETAILED DESCRIPTION

The pet waste bags and methods of use and production thereof described herein advantageously provide a pet waste bag where the end of the waste bag that includes the opening is easy to identify, where the pet waste bag is easy to peel open, where the pet waste bag is easy and quick to seal closed, and where the pet waste bag is securely closed such that it locks in the waste and the undesirable odor.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

The section headings used herein are for organizational purposes only and are not to be construed as limiting the subject matter described.

### I. Pet Waste Bags

The present disclosure provides pet waste bags, e.g., pet waste bags as described herein in any of the foregoing embodiments.

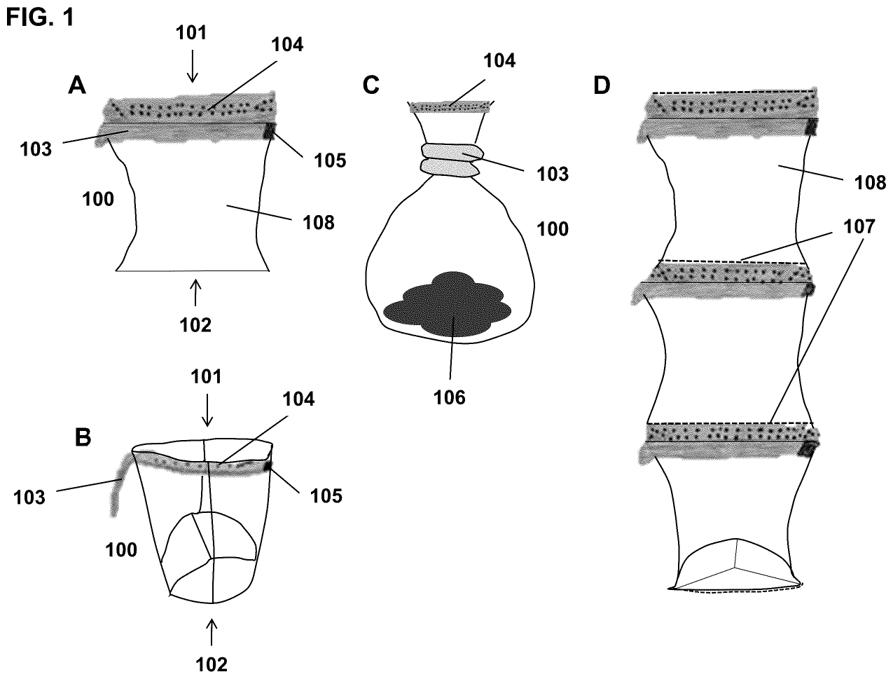

Specifically provided herein is a pet waste bag 100 comprising a body portion 108 comprising an open end 101 and a closed end 102, and, in some embodiments, a fastener 103, such as depicted in FIG. 1A and FIG. 1B; and/or a gripping texture 104, such as depicted in FIGS. 1A-C. Accordingly, in some embodiments, provided herein is a pet waste bag comprising a body portion comprising an open end and a closed end, and a fastener connected to the body portion, and, optionally, a gripping texture. In some embodiments, provided herein is a pet waste bag comprising a body portion comprising an open end and a closed end, and a gripping texture, and, optionally, a fastener.

The open end is the end of the bag that includes the opening for receiving the pet waste. The closed end is the end of the bag, sometimes referred to as the base or bottom, that is permanently or irreversibly closed or sealed and is used for securing the pet waste inside of the pet waste bag. In some embodiments, the pet waste bag 100 comprises a gripping texture 104. In some embodiments, the gripping texture is located on the outside and/or inside of a portion of the open end of the body portion, such as within or without about 2 inches of the open end 101. The gripping texture provides for benefits that include allowing the user to identify which end of the pet waste bag includes the opening, e.g., the open end, as well as allowing the user to more easily peel open the bag due to increased friction between the user's hand, i.e., finger(s), and the pet waste bag.

In some embodiments, the fastener 103 is attached to the body portion 108 at or near the open end 101 of the body portion of the pet waste bag, such as depicted in FIG. 1A or FIG. 1B. In some embodiments, the fastener is part of the open end of the body portion of the pet waste bag. In some embodiments, the fastener is located on the outside of a portion of the open end of the body portion, such as at or near the middle of the body portion or within or within about 50% of the distance from the middle of the body portion to the open end of the body portion. In some embodiments, the portion of the open end comprises the rim of the open end.

In some embodiments, the fastener is connected to the body portion by an adhesive 105 or an adhesive tape 109 comprising an adhesive.

In some embodiments, the fastener is connected to the body portion by an adhesive. In such embodiments, the adhesive secures the fastener to the body portion. In some embodiments, the adhesive is or comprises a non-metallic substance that directly binds the fastener to the body portion. In some embodiments, the adhesive is or comprises an acrylic-based adhesive, a silicone-based adhesive, or a rubber-based adhesive. In some embodiments, the adhesive is or comprises an acrylic-based adhesive. In some embodiments, the adhesive is or comprises a silicone-based adhesive. In some embodiments, the adhesive is or comprises a rubber-based adhesive. In some embodiments, the adhesive is or comprises a cyanoacrylate adhesive. In some embodiments, the adhesive provides for an irreversible connection between the fastener and the body portion.

In some embodiments, the fastener is connected to the body portion by an adhesive tape comprising an adhesive. In some embodiments, the adhesive tape secures the fastener to the body portion. In some embodiments, the adhesive tape comprises a non-metallic substance that directly binds the adhesive tape to the fastener and the body portion. In some embodiments, the adhesive tape comprises an acrylic-based adhesive, a silicone-based adhesive, or a rubber-based adhesive. In some embodiments, the adhesive tape comprises an acrylic-based adhesive. In some embodiments, the adhesive tape comprises a silicone-based adhesive. In some embodiments, the adhesive tape comprises a rubber-based adhesive. In some embodiments, the adhesive tape comprises a cyanoacrylate adhesive. In some embodiments, the adhesive of the adhesive tape provides for an irreversible connection between the adhesive tape and the body portion, thereby irreversibly conntecting the fastener to the body portion.

In some embodiments, the adhesive tape comprises a non-adhesive backing. The non-adhesive backing can, in some embodiments, comprise any non-adhesive material that is suitable for use on a pet waste bag, such as any pet waste bag described herein. In some embodiments, the adhesive tape comprises a vinyl backing and a rubber-based adhesive. In some embodiments, the vinyl backing is a polyvinyl chloride (PVC) backing. In some embodiments, the adhesive tape comprises an acrylic-based adhesive. In some embodiments, the adhesive tape comprises an acrylic-based adhesive and a backing selected from the group consisting of a polyester backing, a polyethylene backing, a polyurethane backing, a polytetrafluoroethylene backing, and a nylon backing. In some embodiments, the adhesive tape comprises an acrylic-based adhesive and a polyethylene backing.

In some embodiments, the fastener is connected to the body portion by an adhesive or an adhesive tape comprising an adhesive inside of the pet waste bag, e.g., inside of the body portion of the pet waste bag. In some embodiments, the fastener is connected to the body portion at a location that is inside the pet waste bag, e.g., on the inside or interior of the body portion of the pet waste bag. In some embodiments, the fastener is connected to the body portion at a location that is outside the pet waste bag, e.g., on the outside or exterior of the body portion of the pet waste bag.

In some embodiments, the fastener is or comprises an elongated material that is capable of bending and retaining its shape.

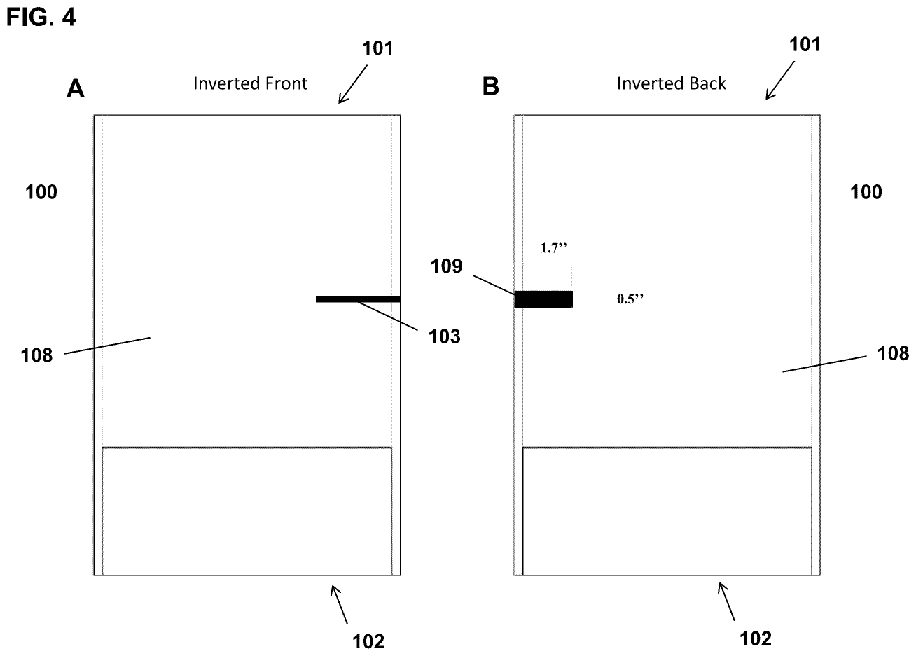

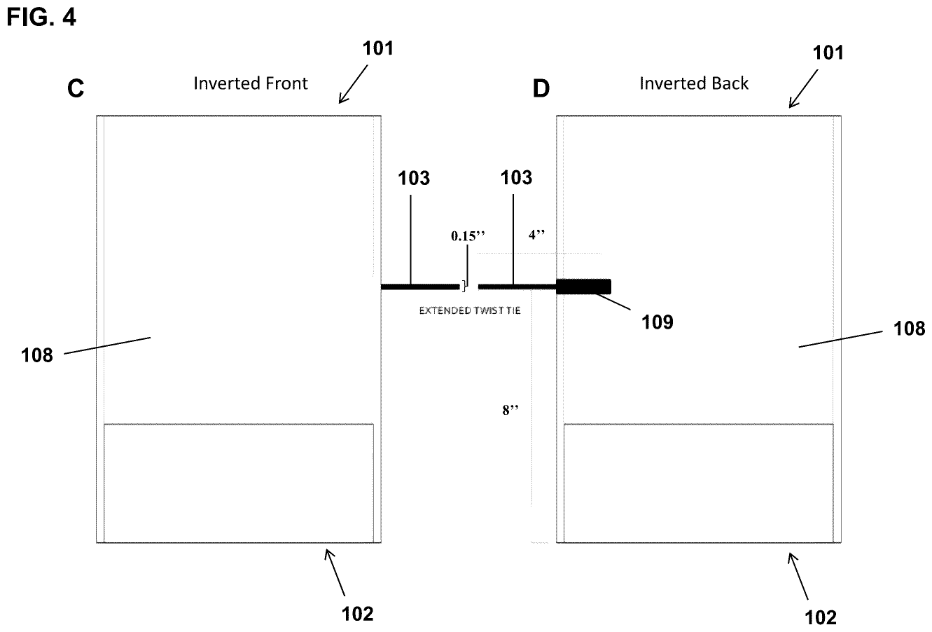

In some embodiments, the fastener is or comprises a twist tie, such as depicted in FIGS. 4A-4D. In some embodiments, the fastener is a twist tie. In some embodiments, the twist tie comprises a wire encased within a non-metallic material such that the wire retains its shape when bent. In some embodiments, the non-metallic material is a paper material, a plastic material, or a rubber material. In some embodiments, the wire is encased within a paper material, a plastic material, a biodegradable material, or a compostable material. In some embodiments, the wire is encased within a paper material.

In some embodiments, the fastener is or comprises a wire. In some embodiments, the fastener is a wire. In some embodiments, the fastener is not encased within a material, e.g., a non-metallic material. In some embodiments, the wire is not encased within a paper material, a plastic material, a biodegradable material, or a compostable material. In some embodiments, the wire is not encased within a paper material or a plastic material. In some embodiments, the wire is encased within a paper material, a plastic material, a biodegradable material, or a compostable material.

In some embodiments, the fastener is not a zipper. In some embodiments, the fastener does not seal the open end. In some embodiments, the open end remains open when the fastener secures the pet waste inside the pet waste bag.

In some embodiments, the fastener peels off of the pet waste bag and remains attached to the pet waste bag, e.g., the body portion of the pet waste bag, at one end. In some embodiments, the fastener remains attached to the pet waste bag, e.g., the body portion of the pet waste bag, due to being connected to the body portion by an adhesive or an adhesive tape comprising an adhesive. As such, in some embodiments, the pet waste bag comprises a body portion comprising an open end, a closed end, a fastener connected to the body portion by an adhesive or an adhesive tape comprising an adhesive. In some embodiments, the body portion is connected to the fastener by the adhesive or the adhesive tape, such that, when the fastener is peeled away from the body portion, it remains attached to the body portion of the pet waste bag at the location of the adhesive or the adhesive tape, e.g., at the location where the adhesive or the adhesive tape connects with the body portion. This allows the fastener to remain attached to the pet waste bag so that the fastener, after being peeled, can be used to seal the pet waste bag closed by wrapping the fastener around the body portion, which seals the bag closed due its ability to bend and retain its shape. In some embodiments, the fastener is configured to wrap around the pet waste bag one or more times.

After peeling fastener away from the pet waste bag, the fastener is used to wrap around and seal the pet waste bag closed after the waste is collected inside of the pet waste bag, such as depicted in FIG. 1C. For instance, in some embodiments, after collecting the waste inside of the pet waste bag, the user can twist the body portion of the pet waste bag closed, thereby enclosing the waste, and then wrap the fastener at or near the twisted portion of the body portion, thereby securing the waste inside the pet waste bag.

In some embodiments, when the fastener is peeled off of the body portion, the fastener remains connected to the body portion by the adhesive or by the adhesive tape. In some embodiments, when peeled, one end of the fastener remains connected to the body portion by the adhesive or by the adhesive tape. In some embodiments, the fastener, when peeled, comprises a portion that is peeled off of the body portion and a portion that is not peeled off of the body portion.

The length of the fastener is not particularly limited and can be any suitable length, e.g., any length suitable for securely closing the pet waste bag. In some embodiments, the fastener is at least 0.5 inch, at least 0.75 inch, at least 1 inch, at least 1.25 inch, at least 1.5 inch, at least 1.75 inch, at least 2 inches, at least 2.25 inches, at least 2.5 inches, at least 2.75 inches, at least 3 inches, at least 3.25 inches, at least 3.5 inches, at least 3.75 inches, at least 4 inches, at least 4.25 inches, at least 4.5 inches, at least 4.75 inches, at least 5 inches, at least 5.25 inches, at least 5.5 inches, at least 5.75 inches, or at least 6 inches in length. In some embodiments, the fastener is between or between about 0.5 inch and 6 inches, between or between about 0.5 and 2 inches, between or between about 1 inch and 6 inches, between or between about 2 inches and 5.5 inches, between or between about 2.5 inches and 5.5 inches, between or between about 3 inches and 5.5 inches, between or between about 3.5 inches and 5.5 inches, between or between about 3.5 inches and 5 inches, between or between about 3.5 inches and 5 inches, or between or between about 3.5 inches and 4.5 inches in length. In some embodiments, the fastener is or is about 0.5 inch, 0.75 inch, 1 inch, 1.25 inch, 1.5 inch, 1.75 inch, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches, 5 inches, 5.25 inches, 5.5 inches, 5.75 inches, or 6 inches in length.

In some embodiments, the fastener, when peeled, can be wrapped around the open end of the pet waste bag that contains waste, thereby sealing the waste inside of the pet waste bag. This can be faster and more efficient than attempting to tie the open end of the pet waste bag closed, and can also allow the user to avoid excessive handling of the pet waste bag that includes the smelly waste. This can also allow for a tighter and more secure sealing of the pet waste bag, thereby reducing the smelly scent that is emitted from the pet waste bag.

In some embodiments, the fastener is located at a site between the open end and the closed end. This allows, for instance, for dividing the bag into a compartment that encloses the pet waste (between the fastener and the closed end) and a portion that can be used by the user to hold onto (between the faster and the open end).

In some embodiments, the fastener comprises a portion that is directly fixed to the body portion by the adhesive or the adhesive tape and a portion that is not directly fixed to the body portion by the adhesive or the adhesive tape. The portion of the fastener that is not directly fixed to the body portion by an adhesive or the adhesive tape can be peeled away from the body portion and used to wrap around the pet waste bag to securely close the pet waste bag around the pet waste. For instance, in some embodiments, when the portion of the fastener that is not directly fixed to the body portion by the adhesive or the adhesive tape is peeled off the body portion, the portion of the fastener that is directly fixed to the body portion by the adhesive or the adhesive tape remains connected to the body portion by the adhesive or by the adhesive tape.

In some embodiments, the portion of the fastener that is directly fixed to the body portion by the adhesive or the adhesive tape is at least or at least about 0.25 inch, 0.5 inch, or 1 inch in length. In some embodiments, the portion of the fastener that is directly fixed to the body portion by the adhesive or the adhesive tape is between or between about 0.5 inch and 5 inches, between or between about 1 inch and 5 inches, between or between about 1.5 inch and 5 inches, between or between about 2 inches and 5 inches, between or between about 0.5 inch and 4 inches, between or between about 1 inch and 4 inches, between or between about 1.5 inch and 4 inches, between or between about 2 inches and 4 inches, between or between about 0.5 inch and 3 inches, between or between about 1 inch and 3 inches, between or between about 1.5 inch and 3 inches, or between or between about 2 inches and 3 inches in length. In some embodiments, the portion that is directly fixed to the body portion by the adhesive or the adhesive tape is or is about 0.25 inch, 0.5 inch, 0.75 inch, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, or 4 inches in length. In some embodiments, the portion that is directly fixed to the body portion by the adhesive or the adhesive tape is between or between about 2 inches and 2.5 inches.

In some embodiments, the fastener is connected to the body portion at a site that is less than 75% of the distance from the open end to the closed end. In some embodiments, the fastener is connected to the body portion at a site that is less than 70% or less than 65% of the distance from the open end to the closed end. In some embodiments, the fastener is connected to the body portion at a site that is less than 60% of the distance from the open end to the closed end. In some embodiments, the fastener is connected to the body portion at a site that is less than 55%, less than 50%, less than 45%, less than 40%, less than 35%, less than 30%, less than 25%, less than 20%, less than 15%, or less than 10% of the distance from the open end to the closed end.

In some embodiments, the fastener is connected to the body portion at a site that is between or between about 5% and 75% of the distance from the open end to the closed end. In some embodiments, the fastener is connected to the body portion at a site that is between or between about 5% and 60% of the distance from the open end to the closed end. In some embodiments, the fastener is connected to the body portion at a site that is between or between about 10% and 75%, between or between about 10% and 70%, between or between about 10% and 65%, between or between about 15% and 75%, between or between about 15% and 70%, between or between about 10% and 60%, between or between about 15% and 55%, between or between about 20% and 50%, between or between about 25% and 45%, between or between about 30% and 45%, between or between about 35% and 45% of the distance from the open end to the closed end.

In some embodiments, the fastener is connected to the body portion at a site that is at or about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75% of the distance from the open end to the closed end. In some embodiments, the fastener is connected to the body portion at a site that is at or about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the distance from the open end to the closed end. In some embodiments, the fastener is connected to the body portion at a site that is at or about 30%, 31%, 32%, 33%, 34%, 35%, 36%, 37%, 38%, 39%, 40%, 41%, 42%, 43%, 44%, or 45% of the distance from the open end to the closed end. In some embodiments, the fastener is connected to the body portion at a site that is at or about 40% or 41% of the distance from the open end to the closed end.

The specific location on the body portion where the fastener is connected is not limiting and can vary depending on, e.g., the size and/or amount of the pet waste to be collected and secured, and/or the size of the pet waste bag. For instance, if the fastener is connected to the body portion at a site that is near the open end, the compartment that is enclosed with the pet waste is larger than if the fastener were connected at a site that is farther away from the open end, i.e., closer to the closed end, but the portion of the pet waste bag that is between the fastener and the open end will be smaller than if the fastener were connected at a site that is farther away from the open end, i.e., closer to the closed end. The portion of the pet waste bag that is between the fastener and the open end can serve as a handle for the user to hold onto the bag with, which allows the user to avoid the undesirable handling the portion of the bag that contains the pet waste bag. For instance, in some embodiments, it may be desirable to have a longer portion of the pet waste bag that is between the fastener and the open end for the user to hold on to when engaging in activity such as running, jogging, or biking alongside their pet, e.g., dog, since this would allow the user to more securely hold onto the bag while avoiding undesirably handling the pet waste portion of the bag.

In some embodiments, the fastener is connected to the body portion at a site that is between or between about 1 inch and 8 inches from the open end. In some embodiments, the fastener is connected to the body portion at a site that is between or between about 1 inch and 7.5 inches, between or between about 1.5 inch and 7 inches, between or between about 2 inches and 7 inches, between or between about 2.5 inches and 7 inches, between or between about 3 inches and 6.5 inches, between or between about 3.5 inches and 6.5 inches, between or between about 4 inches and 6.5 inches, between or between about 4 inches and 6 inches, between or between about 4.5 inches and 6 inches, or between or between about 5 inches and 6 inches from the open end. In some embodiments, the fastener is connected to the body portion at a site that is at or about 1 inch, 1.5 inches, 2 inches, 2.5 inches, 3 inches, 3.5 inches, 4 inches, 4.5 inches, 5 inches, 5.5 inches, 6 inches, 6.5 inches, 7 inches, 7.5 inches, or 8 inches from the open end. In some embodiments, the fastener is connected to the body portion at a site that is at or about 4.5 inches, 5 inches, 5.5 inches, 6 inches, or 6.5 inches from the open end. In some embodiments, the fastener is connected to the body portion at a site that is at or about 5.5 inches from the open end.

In some embodiments, the open end comprises a rim and the fastener is connected to the body portion at a site that is on or adjacent to the rim. In some embodiments, the fastener is connected to the body portion at a site that is no more than 0.5 inch, 1 inch, 1.5 inch, 2 inches, 2.5 inches, 3 inches, 3.5 inches, 4 inches, 4.5 inches, 5 inches, 5.5 inches, 6 inches, 6.5 inches, or 7 inches from the rim.

The length and width of the pet waste bag are not particularly limited and can be any size suitable for collecting and securing pet waste, which differs based on, e.g., the type of pet and, e.g., its size, age, and breed. In some embodiments, the distance from the open end to the closed end (e.g., the length) is between or between about 4 inches and 20 inches. In some embodiments, the distance from the open end to the closed end is between or between about 8 inches and 18 inches, between or between about 8 inches and 16 inches, between or between about 10 inches and 16 inches, between or between about 12 inches and 16 inches, or between or between about 12 inches and 14 inches. In some embodiments, the distance from the open end to the closed end is between or between about 4 inches and 20 inches, between or between about 5 inches and 18 inches, between or between about 6 inches and 16 inches, between or between about 8 inches and 16 inches, between or between about 10 inches and 16 inches, between or between about 12 inches and 16 inches, or between or between about 12 inches and 14 inches. In some embodiments, the distance from the open end to the closed end is at or about 4 inches, 4.5 inches, 5 inches, 5.5 inches, 6 inches, 6.5 inches, 7 inches, 7.5 inches, 8 inches, 8.5 inches, 9 inches, 9.5 inches, 10 inches, 10.5 inches, 11 inches, 11.5 inches, 12 inches, 12.5 inches, 13 inches, 13.5 inches, 14 inches, 14.5 inches, 15 inches, 15.5 inches, 16 inches, 16.5 inches, 17 inches, 17.5 inches, or 18 inches. In some embodiments, the distance from the open end to the closed end is at or about 5 inches, 5.5 inches, 6 inches, 6.5 inches, 7 inches, 7.5 inches, 8 inches, 8.5 inches, 9 inches, 9.5 inches, 10 inches, 10.5 inches, 11 inches, 11.5 inches, 12 inches, 12.5 inches, 13 inches, 13.5 inches, 14 inches, 14.5 inches, 15 inches, 15.5 inches, 16 inches, 16.5 inches, 17 inches, 17.5 inches, 18, 18.5 inches, 19 inches, 19.5 inches, or 20 inches. In some embodiments, the distance from the open end to the closed end is at or about 12 inches, 12.5 inches, 13 inches, 13.5 inches, or 14 inches. In some embodiments, the distance from the open end to the closed end is at or about 13.5 inches. In some embodiments, the distance from the open end to the closed end is at or about 6 inches, 6.5 inches, 7 inches, 7.5 inches, 8 inches, 8.5 inches, 9 inches, 9.5 inches, or 10 inches.

In some embodiments, the pet waste bag further comprises a gripping texture. Accordingly, in some embodiments, the pet waste bag comprises a body portion comprising an open end and a closed end; a fastener; and a gripping texture.

Also provided herein, in some embodiments, is a pet waste bag comprising a body portion comprising an open end and a closed end; and a gripping texture.

In some embodiments comprising a gripping texture, the gripping texture can comprise any texture that provides an increase in friction between the user's finger and the pet waste bag, as compared to the non-textured parts of the pet waste bag.

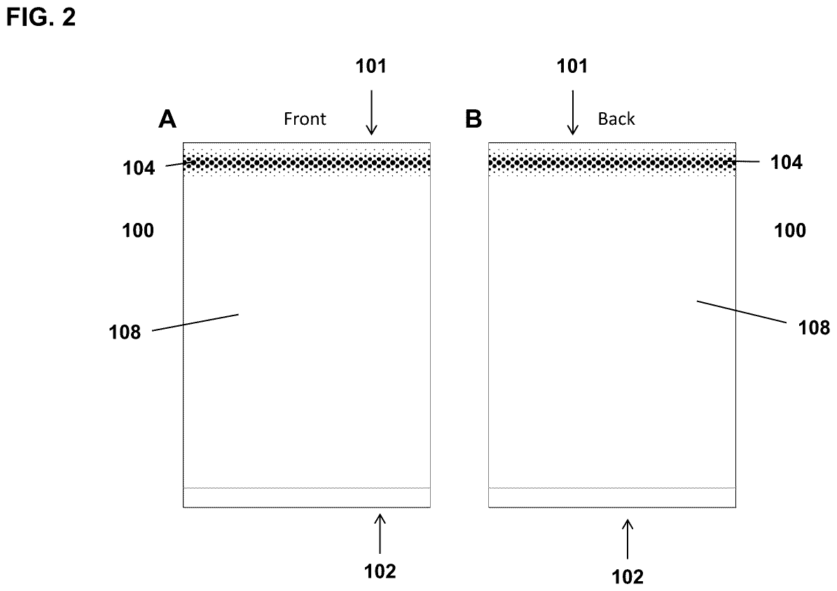

In some embodiments, the gripping texture comprises a raised texture. In some embodiments, the raised texture comprises one or more of raised dots, raised lines, ridges, raised shapes, or any other raised pattern or style, or any combination thereof. In some embodiments, the raised texture comprises raised dots, such as depicted in FIGS. 2A and 2B. The raised dots can, in some embodiments, resemble Braille. The raised shapes can be in any shape, such as a circle, square, oval, ring, ellipse, semi-circle, diamond, star, arrow, cross, heart, pentagon, rhombus, triangle, octagon, plus, minus, ring, etc. In some embodiments, the raised texture comprises one or more of raised dots, raised lines, ridges, raised shapes, or any combination thereof, in one or more sizes. For instance, in some embodiments, the gripping texture comprises one or more of raised dots, raised lines, ridges, raised shapes, or any other raised pattern or style, or any combination thereof, in two or more different sizes, such as depicted in FIGS. 2A and 2B.

In some embodiments, the gripping texture is attached to the open end of the body portion of the pet waste bag. In some embodiments, the gripping texture is located on or adjacent to the open end. In some embodiments, the gripping texture is part of the open end of the body portion of the pet waste bag. For instance, in some embodiments, the open end of the pet waste bag is molded, pressed, or otherwise produced such that it comprises the gripping texture. In some embodiments, the pet waste bag is plastic and the gripping texture is molded into the plastic.

In some embodiments, the gripping texture comprises a friction material that exhibits increased friction between the user's hand and the friction material as compared to the friction between the user's hand and the material of the body portion of the pet waste bag to which the friction material is applied, such as plastic or paper. The friction material can be any suitable material that can be applied to the body portion of the pet waste bag and that exhibits increased friction between the user's hand and the friction material as compared to the friction between the user's hand and the material of the body portion of the pet waste bag to which the friction material is applied, such as plastic or paper.

In some embodiments, the gripping texture is located on the outside of a portion of the open end of the body portion. In some embodiments, the gripping texture is located on the inside of a portion of the open end of the body portion. In some embodiments, the gripping texture is located on the outside and inside of a portion of the open end of the body portion. In some embodiments, the portion of the open end comprises the rim of the open end. In some embodiments, the gripping texture is located on less than 5%, less than 10%, less than 15%, less than 20%, less than 25%, less than 30%, less than 35%, less than 40%, less than 45%, less than 50%, less than 55%, less than 60%, less than 65%, less than 70%, less than 75%, less than 80%, less than 85%, less than 90%, or less than 95% of the perimeter of the rim of the open end. In some embodiments, the gripping texture is located on about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the perimeter of the rim of the open end. In some embodiments, the gripping texture is located on about 50% of the perimeter of the rim of the open end. In some embodiments, the gripping texture is located on 100% of the perimeter of the rim of the open end. In some embodiments, the gripping texture is located on at least or at least about 10% of the perimeter of the rim. In some embodiments, the gripping texture is located on about 1% to about 10%, about 1% to about 20%, about 5% to about 20%, about 5% to about 30%, about 5% to about 40%, about 5% to about 50%, about 10% to about 20%, about 10% to about 40%, about 10% to about 50%, about 10% to about 60%, about 20% to about 40%, about 20% to about 60%, about 20% to about 80%, about 40% to about 95%, about 40% to about 85%, about 40% to about 75%, about 25% to about 75%, about 30% to about 70%, about 35% to about 65%, about 40% to about 60%, or about 45% to about 55% of the perimeter of the rim of the open end.

In some embodiments, the perimeter of the rim of the open end is not particularly limited and can be any suitable length. In some embodiments, the perimeter of the rim of the open end is or is approximately the same as the perimeter of the grabber when the grabber is in an open position. In some embodiments, the perimeter of the rim of the open end is about 0.25 to 1 inch larger than the perimeter of the grabber when the grabber is in an open position. In some embodiments, the perimeter of the rim of the open end is about 0.25 inch, 0.5 inch, 0.75 inch, or 1 inch larger than the perimeter of the grabber when the grabber is in an open position. In some embodiments, the perimeter of the rim of the open end is or is about 6 inches, is or is about 7 inches, is or is about 8 inches, is or is about 9 inches, is or is about 10 inches, is or is about 11 inches, is or is about 12 inches, is or is about 13 inches, is or is about 14 inches, is or is about 15 inches, is or is about 16 inches, is or is about 17 inches, or is or is about 18 or more inches. In some embodiments, the perimeter of the rim of the open end is or is about 6 to 18 inches, is or is about 7 to 17 inches, is or is about 8 to 16 inches, is or is about 9 to 15 inches, is or is about 10 to 14 inches, or is or is about 11 to 13 inches.

In some embodiments, the gripping texture extends for about 0.25 inch, 0.5 inch, about 0.75 inch, about 1 inch, about 1.5 inch, about 2 inches, about 2.5 inches, about 3 inches, about 3.5 inches, about 4 inches, about 4.5 inches, about 5 inches, about 5.5 inches, about 6 inches, about 6.5 inches, about 7 inches, about 7.5 inches, about 8 inches, about 9 inches, about 10 inches, about 11 inches, about 12 inches, about 13 inches, about 14 inches, about 15 inches, about 16 inches, about 17 inches, or about 18 or more inches. In some embodiments, the gripping texture extends for up to about 0.5 inch, up to about 1 inch, up to about 2 inches, up to about 3 inches, up to about 4 inches, up to about 5 inches, up to about 6 inches, up to about 7 inches, up to about 8 inches, up to about 9 inches, up to about 10 inches, up to about 11 inches, up to about 12 inches, up to about 13 inches, up to about 14 inches, up to about 15 inches, up to about 16 inches, up to about 17 inches, or up to about 18 inches.

In some embodiments, the gripping texture is located on at least 10%, 20%, 30%, 40%, 50%, 60%, 70%, 80%, or 90% of the perimeter of the body portion. In some embodiments, the gripping texture is located on or on about 90%, 91%, 92%, 93%, 94%, 95%, 96%, 97%, 98%, 99%, or 100% of the perimeter of the body portion. In some embodiments, the gripping texture is located on between or between about 10% and 100%, between or between about 20% and 90%, between or between about 20% and 80%, between or between about 30% and 70%, between or between about 40% and 60%, between or between about 30% and 100%, between or between about 40% and 100%, between or between about 50% and 100%, between or between about 10% and 50%, between or between about 10% and 40%, between or between about 10% and 30%, between or between about 20% and 50%, between or between about 30% and 50%, or between or between about 40% and 50% of the perimeter of the body portion. In some embodiments, the gripping texture is located on or on about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53% 54%, or 55% of the perimeter of the body portion. In some embodiments, the gripping texture is located on or on about 50% of the perimeter of the body portion.

In some embodiments, the gripping texture extends for at least 1 inch along the perimeter of the body portion. In some embodiments, the gripping texture extends for a length of between or between about 1 inch and 24 inches along the perimeter of the body portion. In some embodiments, the gripping texture extends for a length of between or between about 1 inch and 24 inches, between or between about 2 inches and 24 inches, between or between about 4 inches and 24 inches, between or between about 6 inches and 24 inches, between or between about 8 inches and 24 inches, between or between about 9 inches and 24 inches, between or between about 10 inches and 24 inches, between or between about 12 inches and 24 inches, between or between about 14 inches and 24 inches, between or between about 16 inches and 24 inches, between or between about 16 inches and 20 inches, between or between about 17 inches and 19 inches, between or between about 1 inch and 12 inches, between or between about 2 inches and 12 inches, between or between about 3 inches and 12 inches, between or between about 4 inches and 12 inches, between or between about 5 inches and 12 inches, between or between about 6 inches and 12 inches, between or between about 7 inches and 10 inches, between or between about 8 inches and 10 inches, between or between about 1 inch and 8 inches, between or between about 2 inches and 7 inches, between or between about 3 inches and 6 inches, or between or between about 4 inches and 5 inches along the perimeter of the body portion.

In some embodiments, the gripping texture is located at or near the open end. By being located at or near the open end, the gripping texture can help the user to open up the bag at the open end so that it can be used to collect and secure pet waste. This can alleviate the difficulty that often arises in opening up a bag, e.g., plastic bag, where the body portion at the open end is stuck together. Thus, the gripping texture of some embodiments of the pet waste bags described herein can allow for easier opening of the pet waste bag on the open end by the user. In some embodiments, the gripping texture is located 1 inch or less from the open end. In some embodiments, the gripping texture is located less than or less than about 0.9 inch, 0.8 inch, 0.7 inch, 0.6 inch, 0.5 inch, 0.4 inch, 0.3 inch, or 0.2 inch from the open end. In some embodiments, the gripping texture is located at or about 0.1 inch, 0.15 inch, 0.2 inch, 0.25 inch, 0.3 inch, 0.35 inch, or 0.4 inch from the open end. In some embodiments, the gripping texture is located at the open end. In some embodiments, the gripping texture is located at or about 0.25 inch from the open end.

In some embodiments, the gripping texture has a width that is not particularly limited and can be any width suitable for allowing a user to open the pet waste bag. In some embodiments, the gripping texture has a width of between or between about 0.1 inch and 2 inches, wherein the width of the gripping texture is the width of the gripping texture in the direction from the open end to the closed end. In some embodiments, the gripping texture has a width of between or between about 0.1 inch and 1.8 inches, between or between about 0.1 inch and 1.6 inches, between or between about 0.1 inch and 1.4 inches, between or between about 0.1 inch and 1.2 inches, between or between about 0.1 inch and 1 inch, between or between about 0.25 inch and 2 inches, between or between about 0.25 inch and 1.8 inches, between or between about 0.25 inch and 1.6 inches, between or between about 0.25 inch and 1.4 inches, between or between about 0.25 inch and 1.2 inches, between or between about 0.25 inch and 1 inch, wherein the width of the gripping texture is the width of the gripping texture in the direction from the open end to the closed end. In some embodiments, the gripping texture has a width of at or about 0.2 inch, 0.25 inch, 0.3 inch, 0.35 inch, 0.4 inch, 0.45 inch, 0.5 inch, 0.55 inch, 0.6 inch, 0.65 inch, 0.7 inch, 0.75 inch, 0.8 inch, 0.85 inch, 0.9 inch, 0.95 inch, 1 inch, 1.05 inches, 1.1 inches, 1.15 inches, 1.2 inches, or 1.25 inches, wherein the width of the gripping texture is the width of the gripping texture in the direction from the open end to the closed end. In some embodiments, the gripping texture has a width of between or between about 0.5 and 1 inch.

The open end of the body portion is not particularly limited and can be any shape or configuration. In some embodiments, the open end is a circle or oval shape. In some embodiments, the open end is flat and comprises a slit, such as the open end of a sandwich bag. In some embodiments, the open end is a triangle shape. In some embodiments, the open end is a square or rectangle shape. In some embodiments, the open end of the body portion configures to the shape of a pet waste scooping device when placed on the device for retrieving pet waste.

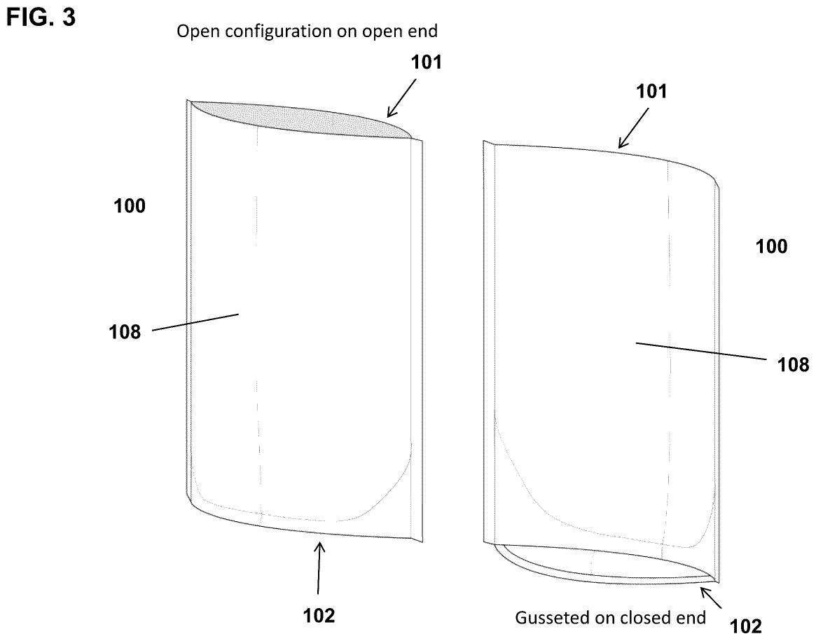

The closed end of the body portion is not particularly limited and can be any shape or configuration. In some embodiments, the closed end is a circle or oval shape. In some embodiments, the closed end is flat, such as the closed end of a sandwich bag. In some embodiments, the closed end is round, such as depicted in FIG. 1B. In some embodiments, the closed end is gusseted, such as depicted in FIG. 3, right. In some embodiments, the closed end is round and half-spherical. In some embodiments, the closed end is a triangle shape. In some embodiments, the closed end is a square or rectangle shape.

The body portion of the pet waste bag can comprise any suitable material for containing pet waste. In some embodiments, the body portion of the pet waste bag comprises plastic. In some embodiments, the plastic is selected from the group consisting of HDPE, LDPE, and LLDPE. In some embodiments, the body portion of the pet waste bag comprises HDPE.

In some embodiments, the body portion of the pet waste bag comprises a biodegradable material or a compostable material. In some embodiments, the body portion comprises a biodegradable material. In some embodiments, the biodegradable material comprises one or more of a cellulose-based material, a starch-based material, a lignin-based material, a soy-based material, a polyactic acid-based material, or a paper-based material. In some embodiments the biodegradable material is a biodegradable plastic material. In some embodiments, the biodegradable plastic material comprises a cellulose-based material.

Also provided herein is a package of pet waste bags, comprising two or more of any of the pet waste bags described herein. In some embodiments, the two or more pet waste bags is, is about, is at least, or is at least about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 125, 150, 175, 200, 225, or 250 ofany of the pet waste bags described herein. In some embodiments, the two or more pet waste bags are linked together. In some embodiments, the two or more pet waste bags are linked together, and are separated by a perforated edge on the open end and/or the closed end of the body portion, which allows for each individual pet waste bag to be torn off and used individually. In some embodiments, each of the two or more pet waste bags is linked to another of the two or more pet waste bags by a perforated edge that separates the open end of one bag from the closed end of another bag. In some embodiments, for each of the two or more pet waste bags, the perforated edge is located on the open end and/or the closed end of the body portion.

In some embodiments, the two or more pet waste bags are not linked together, e.g., the two or more pet waste bags are separate from one another within the package. In some embodiments, each of the two or more pet waste bags is separate from each of the other two or more pet waste bags.

### II. Pet Waste Collection Kit

Also provided herein is a pet waste collection kit, comprising any pet waste bag described herein, and a pet waste scooping device, e.g., any pet waste scooping device.

In some embodiments, the pet waste collection kit further comprises instructions for use of the pet waste collection kit, including instructions for use of the pet waste scooping device and/or instructions for use of the pet waste bag.

### III. Methods of Manufacturing

Provided herein are methods of manufacturing a pet waste bag, including any pet waste bag described herein, e.g., in section I. In some embodiments, the method comprises obtaining a body portion comprising an open end and a closed end, and connecting a fastener to the body portion. In some embodiments, the method comprises obtaining a body portion comprising an open end and a closed end, connecting a fastener to the body portion, and applying a gripping texture to the body portion.

In some embodiments, the fastener is connected to the body portion by an adhesive. In some embodiments, the fastener is connected to the body portion by an adhesive tape comprising an adhesive.

In some embodiments, the fastener is connected to the body portion at a location that is within 7 inches from the open end of the body portion.

In some embodiments, the fastener is a twist tie.

In some embodiments, the fastener is a wire. In some embodiments, the wire is encased within a material. In some embodiments, the wire is not encased within a material.

In some embodiments, the twist tie comprises a wire. In some embodiments, the wire is encased within a paper material, a plastic material, a biodegradable material, or a compostable material. In some embodiments, the wire is encased within a paper material.

In some embodiments, the gripping texture is applied to the outside and/or inside of a portion of the open end of the body portion. In some embodiments, the gripping texture is applied to a portion of the open end that comprises the rim of the open end. In some embodiments, the gripping texture is applied to the body portion at a location that is within or within about 2 inches from the open end of the body portion.

Also provided herein are methods of manufacturing a pet waste collection kit, including any pet waste collection kit described herein. In some embodiments, the method comprises obtaining a pet waste scooping device, and obtaining a pet waste bag. In some embodiments, the pet waste scooping device is any pet waste scooping device known in the art, and the pet waste bag is any pet waste bag described herein, such as in section I, and/or any pet waste bag obtained by using any of the methods of manufacturing described herein, such as in section III.

### IV. Methods of Using

Provided herein are methods of using any of the pet waste bags provided herein, or the pet waste collection kits provided herein.

In some embodiments, provided herein is a method of using a pet waste bag, comprising: obtaining a pet waste bag, e.g., any pet waste bag provided herein that comprises a fastener; securing pet waste inside of the pet waste bag; and sealing the pet waste bag using the fastener. In some embodiments, the method further comprises peeling open the open end of the pet waste bag using the gripping texture. In some embodiments, the method further comprises twisting the body portion of the pet waste bag into a closed configuration or a substantially closed configuration prior to sealing the pet waste bag closed using the fastener. In some embodiments, sealing the pet waste bag closed using the fastener comprises wrapping the fastener around the body portion of the pet waste bag one or more times at or near the location where the body portion was twisted. In some embodiments, sealing the pet waste bag closed using the fastener comprises wrapping the fastener around the body portion of the pet waste bag one or more times. In some embodiments, the sealing results in an airtight or substantially airtight seal around the pet waste.

In some of any of such embodiments, the pet waste bag is inverted prior to the securing pet waste inside of the pet waste bag and the sealing the pet waste bag using the fastener. In some embodiments, the fastener is located inside the body portion of the pet waste bag and inverting the pet waste bag allows for the fastener to be accessible for sealing the pet waste bag.

In some embodiments, provided herein is a method of using a pet waste bag, comprising: obtaining a pet waste bag, e.g., any pet waste bag provided herein that comprises a gripping texture; peeling open the open end of the pet waste bag using the gripping texture; securing the pet waste inside of the pet waste bag; and closing the pet waste bag. In some embodiments, the pet waste bag further comprises a fastener, and the closing the pet waste bag comprises sealing the pet waste bag closed using the fastener.

In some embodiments, provided herein is a method using a pet waste collection kit, the method comprising: obtaining a pet waste scooping device; obtaining a pet waste bag described herein; opening the pet waste bag; placing the pet waste bag over the pet waste scooping device or a portion thereof; and collecting pet waste.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” include plural referents unless the context clearly dictates otherwise. For example, “a” or “an” means “at least one” or “one or more.” It is understood that aspects and variations described herein include “consisting” and/or “consisting essentially of” aspects and variations.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

Reference to “the perimeter of the rim of the open end” refers to the length around the opening of the pet waste bag, which can be calculated, for instance, in terms of centimeters or inches. The perimeter can be calculated by any acceptable means, including measuring the length around the opening of the pet waste bag or by use of a formula for calculating the perimeter of a shape.

The term “biodegradable” as used herein, e.g., a biodegradable material, refers to a material that is capable of being decomposed by bacteria or other living organisms.

### V. Exemplary Embodiments

Provided herein are the following exemplary embodiments:

1. A pet waste bag, comprising:
a body portion comprising an open end and a closed end; and
a fastener connected to the body portion.
   2. The pet waste bag of embodiment 1, wherein the fastener is connected to the body portion by an adhesive or by an adhesive tape comprising an adhesive.
   3. The pet waste bag of embodiment 1, wherein the fastener is connected to the body portion by an adhesive.
   4. The pet waste bag of embodiment 3, wherein the adhesive is or comprises a non-metallic substance that directly binds the fastener to the body portion.
   5. The pet waste bag of embodiment 1, wherein the fastener is connected to the body portion by an adhesive tape comprising an adhesive.
   6. The pet waste bag of embodiment 5, wherein the adhesive tape secures the fastener to the body portion.
   7. The pet waste bag of embodiment 5 or embodiment 6, wherein the adhesive tape comprises a non-metallic substance that directly binds the adhesive tape to the fastener and the body portion.
   8. The pet waste bag of embodiment 3 or embodiment 4, wherein the adhesive is or comprises an acrylic-based adhesive, a silicone-based adhesive, or a rubber-based adhesive.
   9. The pet waste bag of any one of embodiments 3, 4, and 8, wherein the adhesive is or comprises a cyanoacrylate adhesive.
   10. The pet waste bag of any one of embodiments 5-7, wherein the adhesive tape comprises an acrylic-based adhesive, a silicone-based adhesive, or a rubber-based adhesive.
   11. The pet waste bag of embodiment 10, wherein the adhesive tape comprises a rubber-based adhesive.
   12. The pet waste bag of any one of embodiments 5-7, wherein the adhesive tape comprises a vinyl backing and a rubber-based adhesive.
   13. The pet waste bag of embodiment 12, wherein the vinyl backing is a polyvinyl chloride (PVC) backing.
   14. The pet waste bag of any one of embodiments 5-7, wherein the adhesive tape comprises an acrylic-based adhesive.
   15. The pet waste bag of any one of embodiments 5-7, wherein the adhesive tape comprises an acrylic-based adhesive and a backing selected from the group consisting of a polyester backing, a polyethylene backing, a polyurethane backing, a polytetrafluoroethylene backing, and a nylon backing.
   16. The pet waste bag of embodiment 15, wherein the adhesive tape comprises an acrylic-based adhesive and a polyethylene backing.
   17. The pet waste bag of any one of embodiments 1-16, wherein the fastener is a twist tie.
   18. The pet waste bag of embodiment 17, wherein the twist tie comprises a wire.
   19. The pet waste bag of embodiment 18, wherein the wire is encased within a paper material, a plastic material, a biodegradable material, or a compostable material.
   20. The pet waste bag of embodiment 18 or embodiment 19, wherein the wire is encased within a paper material.
   21. The pet waste bag of any one of embodiments 1-16, wherein the fastener is or comprises a wire.
   22. The pet waste bag of embodiment 21, wherein the wire is not encased within a material.
   23. The pet waste bag of embodiment 21 or embodiment 22, wherein the wire is not encased within a paper material or a plastic material.
   24. The pet waste bag of embodiment 21, wherein the wire is encased within a paper material, a plastic material, a biodegradable material, or a compostable material.
   25. The pet waste bag of any one of embodiments 1-24, wherein the fastener is connected to the body portion at a site that is less than 60% of the distance from the open end to the closed end.
   26. The pet waste bag of any one of embodiments 1-25, wherein the fastener is connected to the body portion at a site that is less than 55%, less than 50%, less than 45%, less than 40%, less than 35%, less than 30%, less than 25%, less than 20%, less than 15%, or less than 10% of the distance from the open end to the closed end.
   27. The pet waste bag of any one of embodiments 1-26, wherein the fastener is connected to the body portion at a site that is between or between about 5% and 60% of the distance from the open end to the closed end.
   28. The pet waste bag of any one of embodiments 1-27, wherein the fastener is connected to the body portion at a site that is between or between about 10% and 60%, between or between about 15% and 55%, between or between about 20% and 50%, between or between about 25% and 45%, between or between about 30% and 45%, between or between about 35% and 45% of the distance from the open end to the closed end.
   29. The pet waste bag of any one of embodiments 1-28, wherein the fastener is connected to the body portion at a site that is at or about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the distance from the open end to the closed end.
   30. The pet waste bag of any one of embodiments 1-29, wherein the fastener is connected to the body portion at a site that is at or about 40% or 41% of the distance from the open end to the closed end.
   31. The pet waste bag of any one of embodiments 1-30, wherein the distance from the open end to the closed end is between or between about 4 inches and 20 inches.
   32. The pet waste bag of any one of embodiments 1-31, wherein the distance from the open end to the closed end is between or between about 4 inches and 20 inches, between or between about 5 inches and 18 inches, between or between about 6 inches and 16 inches, between or between about 8 inches and 16 inches, between or between about 10 inches and 16 inches, between or between about 12 inches and 16 inches, or between or between about 12 inches and 14 inches.
   33. The pet waste bag of any one of embodiments 1-32, wherein the distance from the open end to the closed end is at or about 5 inches, 5.5 inches, 6 inches, 6.5 inches, 7 inches, 7.5 inches, 8 inches, 8.5 inches, 9 inches, 9.5 inches, 10 inches, 10.5 inches, 11 inches, 11.5 inches, 12 inches, 12.5 inches, 13 inches, 13.5 inches, 14 inches, 14.5 inches, 15 inches, 15.5 inches, 16 inches, 16.5 inches, 17 inches, 17.5 inches, or 18 inches.
   34. The pet waste bag of any one of embodiments 1-33, wherein the distance from the open end to the closed end is at or about 13.5 inches.
   35. The pet waste bag of any one of embodiments 1-34, wherein the fastener is connected to the body portion at a site that is between or between about 1 inch and 8 inches from the open end.
   36. The pet waste bag of any one of embodiments 1-35, wherein the fastener is connected to the body portion at a site that is between or between about 1 inch and 7.5 inches, between or between about 1.5 inch and 7 inches, between or between about 2 inches and 7 inches, between or between about 2.5 inches and 7 inches, between or between about 3 inches and 6.5 inches, between or between about 3.5 inches and 6.5 inches, between or between about 4 inches and 6.5 inches, between or between about 4 inches and 6 inches, between or between about 4.5 inches and 6 inches, or between or between about 5 inches and 6 inches from the open end.
   37. The pet waste bag of embodiment 36, wherein the fastener is connected to the body portion at a site that is at or about 1 inch, 1.5 inches, 2 inches, 2.5 inches, 3 inches, 3.5 inches, 4 inches, 4.5 inches, 5 inches, 5.5 inches, 6 inches, 6.5 inches, 7 inches, 7.5 inches, or 8 inches from the open end.
   38. The pet waste bag of embodiment 36 or embodiment 37, wherein the fastener is connected to the body portion at a site that is at or about 5.5 inches from the open end.
   39. The pet waste bag of any one of embodiments 1-26 and 31-34, wherein the open end comprises a rim and the fastener is connected to the body portion at a site that is on or adjacent to the rim.
   40. The pet waste bag of any one of embodiments 1-26, 31-34, and 39, wherein the fastener is connected to the body portion at a site that is no more than 0.5 inch, 1 inch, 1.5 inch, 2 inches, 2.5 inches, 3 inches, 3.5 inches, 4 inches, 4.5 inches, 5 inches, 5.5 inches, 6 inches, 6.5 inches, or 7 inches from the rim.
   41. The pet waste bag of embodiment 40, wherein the distance from the open end to the closed end is between or between about 8 inches and 18 inches, between or between about 8 inches and 16 inches, between or between about 10 inches and 16 inches, between or between about 12 inches and 16 inches, or between or between about 12 inches and 14 inches.
   42. The pet waste bag of any one of embodiments 2-41, wherein, when the fastener is peeled off of the body portion, the fastener remains connected to the body portion by the adhesive or by the adhesive tape.
   43. The pet waste bag of any one of embodiments 1-42, wherein the fastener is at least 0.5 inch, at least 0.75 inch, at least 1 inch, at least 1.25 inch, at least 1.5 inch, at least 1.75 inch, at least 2 inches, at least 2.25 inches, at least 2.5 inches, at least 2.75 inches, at least 3 inches, at least 3.25 inches, at least 3.5 inches, at least 3.75 inches, at least 4 inches, at least 4.25 inches, at least 4.5 inches, at least 4.75 inches, at least 5 inches, at least 5.25 inches, at least 5.5 inches, at least 5.75 inches, or at least 6 inches in length.
   44. The pet waste bag of any one of embodiments 1-43, wherein the fastener is between or between about 1 inch and 6 inches, between or between about 2 inches and 5.5 inches, between or between about 2.5 inches and 5.5 inches, between or between about 3 inches and 5.5 inches, between or between about 3.5 inches and 5.5 inches, between or between about 3.5 inches and 5 inches, between or between about 3.5 inches and 5 inches, or between or between about 3.5 inches and 4.5 inches in length.
   45. The pet waste bag of any one of embodiments 2-44, wherein the fastener comprises a portion that is directly fixed to the body portion by the adhesive or the adhesive tape and a portion that is not directly fixed to the body portion by the adhesive or the adhesive tape.
   46. The pet waste bag of embodiment 45, wherein the portion that is directly fixed to the body portion by the adhesive or the adhesive tape is between or between about 0.5 inch and 5 inches, between or between about 1 inch and 5 inches, between or between about 1.5 inch and 5 inches, between or between about 2 inches and 5 inches, between or between about 0.5 inch and 4 inches, between or between about 1 inch and 4 inches, between or between about 1.5 inch and 4 inches, between or between about 2 inches and 4 inches, between or between about 0.5 inch and 3 inches, between or between about 1 inch and 3 inches, between or between about 1.5 inch and 3 inches, or between or between about 2 inches and 3 inches in length.
   47. The pet waste bag of embodiment 45 or embodiment 46, wherein the portion that is directly fixed to the body portion by the adhesive or the adhesive tape is or is about 0.25 inch, 0.5 inch, 0.75 inch, 1 inch, 1.25 inches, 1.5 inches, 1.75 inches, 2 inches, 2.25 inches, 2.5 inches, 2.75 inches, 3 inches, 3.25 inches, 3.5 inches, 3.75 inches, or 4 inches in length.
   48. The pet waste bag of embodiment 45 or embodiment 46, wherein the portion that is directly fixed to the body portion by the adhesive or the adhesive tape is between or between about 2 inches and 2.5 inches.
   49. The pet waste bag of any one of embodiments 45-48, wherein, when the portion of the fastener that is not directly fixed to the body portion by the adhesive or the adhesive tape is peeled off the body portion, the portion of the fastener that is directly fixed to the body portion by the adhesive or the adhesive tape remains connected to the body portion by the adhesive or by the adhesive tape.
   50. The pet waste bag of any one of embodiments 1-49, further comprising a gripping texture.
   51. A pet waste bag, comprising:
a body portion comprising an open end and a closed end; and
a gripping texture.
   52. The pet waste bag of embodiment 51, further comprising a fastener.
   53. The pet waste bag of any one of embodiments 50-52, wherein the gripping texture comprises a raised texture.
   54. The pet waste bag of embodiment 53, wherein the raised texture comprises one or more of raised dots, raised lines, ridges, raised shapes, or any combination thereof.
   55. The pet waste bag of embodiment 54, wherein the raised texture comprises one or more of raised dots, raised lines, ridges, raised shapes, or any combination thereof, in one or more sizes.
   56. The pet waste bag of any one of embodiments 50-55, wherein the gripping texture is located on or adjacent to the open end.
   57. The pet waste bag of any one of embodiments 50-56, wherein the open end comprises a rim and the gripping texture is located on or adjacent to the rim.
   58. The pet waste bag of embodiment 57, wherein the gripping texture is located on at least or at least about 10% of the perimeter of the rim.
   59. The pet waste bag of any one of embodiments 50-58, wherein the gripping texture is located on at least 10%, 20%, 30%, 40%, 50%, 60%, 70%, 80%, or 90% of the perimeter of the body portion.
   60. The pet waste bag of any one of embodiments 50-58, wherein the gripping texture is located on or on about 90%, 91%, 92%, 93%, 94%, 95%, 96%, 97%, 98%, 99%, or 100% of the perimeter of the body portion.
   61. The pet waste bag of any one of embodiments 50-58, wherein the gripping texture is located on between or between about 10% and 100%, between or between about 20% and 90%, between or between about 20% and 80%, between or between about 30% and 70%, between or between about 40% and 60%, between or between about 30% and 100%, between or between about 40% and 100%, between or between about 50% and 100%, between or between about 10% and 50%, between or between about 10% and 40%, between or between about 10% and 30%, between or between about 20% and 50%, between or between about 30% and 50%, or between or between about 40% and 50% of the perimeter of the body portion.
   62. The pet waste bag of any one of embodiments 50-58, wherein the gripping texture is located on or on about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53% 54%, or 55% of the perimeter of the body portion.
   63. The pet waste bag of any one of embodiments 50-62, wherein the gripping texture extends for a length of between or between about 1 inch and 24 inches along the perimeter of the body portion.
   64. The pet waste bag of any one of embodiments 50-63, wherein the gripping texture extends for a length of between or between about 1 inch and 24 inches, between or between about 2 inches and 24 inches, between or between about 4 inches and 24 inches, between or between about 6 inches and 24 inches, between or between about 8 inches and 24 inches, between or between about 9 inches and 24 inches, between or between about 10 inches and 24 inches, between or between about 12 inches and 24 inches, between or between about 14 inches and 24 inches, between or between about 16 inches and 24 inches, between or between about 16 inches and 20 inches, between or between about 17 inches and 19 inches, between or between about 1 inch and 12 inches, between or between about 2 inches and 12 inches, between or between about 3 inches and 12 inches, between or between about 4 inches and 12 inches, between or between about 5 inches and 12 inches, between or between about 6 inches and 12 inches, between or between about 7 inches and 10 inches, between or between about 8 inches and 10 inches, between or between about 1 inch and 8 inches, between or between about 2 inches and 7 inches, between or between about 3 inches and 6 inches, or between or between about 4 inches and 5 inches along the perimeter of the body portion.
   65. The pet waste bag of any one of embodiments 50-64, wherein the gripping texture is located 1 inch or less from the open end. 66. The pet waste bag of any one of embodiments 50-65, wherein the gripping texture is located less than or less than about 0.9 inch, 0.8 inch, 0.7 inch, 0.6 inch, 0.5 inch, 0.4 inch, 0.3 inch, or 0.2 inch from the open end.
   67. The pet waste bag of any one of embodiments 50-66, wherein the gripping texture is located at or about 0.1 inch, 0.15 inch, 0.2 inch, 0.25 inch, 0.3 inch, 0.35 inch, or 0.4 inch from the open end.
   68. The pet waste bag of any one of embodiments 50-67, wherein the gripping texture has a width of between or between about 0.1 inch and 2 inches, wherein the width of the gripping texture is the width of the gripping texture in the direction from the open end to the closed end.
   69. The pet waste bag of any one of embodiments 50-68, wherein the gripping texture has a width of between or between about 0.1 inch and 1.8 inches, between or between about 0.1 inch and 1.6 inches, between or between about 0.1 inch and 1.4 inches, between or between about 0.1 inch and 1.2 inches, between or between about 0.1 inch and 1 inch, between or between about 0.25 inch and 2 inches, between or between about 0.25 inch and 1.8 inches, between or between about 0.25 inch and 1.6 inches, between or between about 0.25 inch and 1.4 inches, between or between about 0.25 inch and 1.2 inches, between or between about 0.25 inch and 1 inch, wherein the width of the gripping texture is the width of the gripping texture in the direction from the open end to the closed end.
   70. The pet waste bag of any one of embodiments 50-68, wherein the gripping texture has a width of at or about 0.2 inch, 0.25 inch, 0.3 inch, 0.35 inch, 0.4 inch, 0.45 inch, 0.5 inch, 0.55 inch, 0.6 inch, 0.65 inch, 0.7 inch, 0.75 inch, 0.8 inch, 0.85 inch, 0.9 inch, 0.95 inch, 1 inch, 1.05 inches, 1.1 inches, 1.15 inches, 1.2 inches, or 1.25 inches, wherein the width of the gripping texture is the width of the gripping texture in the direction from the open end to the closed end.
   71. The pet waste bag of any one of embodiments 1-70, wherein the body portion comprises plastic.
   72. The pet waste bag of embodiment 71, wherein the plastic is selected from the group consisting of high-density polyethylene (HDPE), low-density polyethylene (LDPE), and linear low-density polyethylene (LLDPE).
   73. The pet waste bag of embodiment 71 or embodiment 72, wherein the body portion of the pet waste bag comprises HDPE.
   74. The pet waste bag of any one of embodiments 1-70, wherein the body portion comprises a biodegradable material or a compostable material.
   75. The pet waste bag of embodiment 74, wherein the body portion comprises a biodegradable material.
   76. The pet waste bag of embodiment 74 or embodiment 75, wherein the biodegradable material is a biodegradable plastic material.
   77. The pet waste bag of any one of embodiments 74-76, wherein the biodegradable material comprises one or more of a cellulose-based material, a starch-based material, a lignin-based material, a soy-based material, a polyactic acid-based material, or a paper-based material.
   78. A package of pet waste bags, comprising two or more of the pet waste bags of any one of embodiments 1-77.
   79. The package of pet waste bags of embodiment 78, wherein the two or more of the pet waste bag is, is about, is at least, or is at least about 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 125, 150, 175, 200, 225, or 250 of the pet waste bag of any one of embodiments 1-77.
   80. The package of pet waste bags of embodiment 78 or embodiment 79, wherein the two or more pet waste bags are linked together.
   81. The package of pet waste bags of any one of embodiments 78-80, wherein each of the two or more pet waste bags is linked to another of the two or more pet waste bags by a perforated edge that separates the open end of one bag from the closed end of another bag.
   82. The package of pet waste bags of embodiment 81, wherein, for each of the two or more pet waste bags, the perforated edge is located on the open end and/or the closed end of the body portion.
   83. A pet waste collection kit, comprising:
a pet waste bag of any one of embodiments 1-77; and
a pet waste scooping device.
   84. The pet waste collection kit of embodiment 83, further comprising instructions for use.
   85. A pet waste collection kit, comprising:
a package of pet waste bags of any one of embodiments 78-82; and
a pet waste scooping device.
   86. The pet waste collection kit of embodiment 85, further comprising instructions for use.
   87. A method of manufacturing a pet waste bag, comprising:
obtaining a body portion comprising an open end and a closed end; and
connecting a fastener to the body portion.
   88. The method of embodiment 87, wherein the fastener is connected to the body portion by an adhesive.
   89. The method of embodiment 87, wherein the fastener is connected to the body portion by an adhesive tape comprising an adhesive.
   90. The method of any one of embodiments 87-89, wherein the fastener is connected to the body portion at a location that is within 7 inches from the open end of the body portion.
   91. The method of any one of embodiments 87-90, wherein the fastener is a twist tie.
   92. The method of embodiment 91, wherein the twist tie comprises a wire.
   93. The method of any one of embodiments 87-90, wherein the fastener is or comprises a wire.
   94. The method of embodiment 92 or embodiment 93, wherein the wire is encased within a paper material, a plastic material, a biodegradable material, or a compostable material.
   95. The method of any one of embodiments 92-94, wherein the wire is encased within a paper material.
   96. The method of any one of embodiments 87-90, wherein the fastener is a wire.
   97. The method of embodiment 96, wherein the wire is not encased within a material.
   98. The method of any one of embodiments 87-97, further comprising applying a gripping texture to the body portion.
   99. A method of manufacturing a pet waste bag, comprising:
obtaining a body portion comprising an open end and a closed end; and
applying a gripping texture to the body portion.
   100. The method of embodiment 98 or embodiment 99, wherein the gripping texture is applied to the body portion at a location that is within or within about 2 inches from the open end of the body portion.
   101. A method of using a pet waste bag, comprising:
obtaining a pet waste bag of any one of embodiments 1-77;
securing pet waste inside of the pet waste bag; and
sealing the pet waste bag closed using the fastener.
   102. The method of embodiment 101, further comprising peeling open the open end of the pet waste bag using the gripping texture.
   103. The method of embodiment 101 or embodiment 102, further comprising twisting the body portion of the pet waste bag into a closed configuration or a substantially closed configuration prior to sealing the pet waste bag closed using the fastener.
   104. The method of any one of embodiments 101-103, wherein sealing the pet waste bag closed using the fastener comprises wrapping the fastener around the body portion of the pet waste bag one or more times at or near the location where the body portion was twisted.
   105. The method of any one of embodiments 101-103, wherein sealing the pet waste bag closed using the fastener comprises wrapping the fastener around the body portion of the pet waste bag one or more times.
   106. The method of any one of embodiments 101-105, wherein the sealing results in an airtight or substantially airtight seal around the pet waste.
   107. A method of using a pet waste bag, comprising:
obtaining a pet waste bag of any one of embodiments 51-77;
peeling open the open end of the pet waste bag using the gripping texture;
securing pet waste inside of the pet waste bag; and
closing the pet waste bag.

1. A pet waste bag, comprising:
a body portion comprising an open end and a closed end; and
a fastener connected to the body portion.

2. The pet waste bag of claim 1, wherein the fastener is connected to the body portion by an adhesive or by an adhesive tape comprising an adhesive.

3-16. (canceled)

17. The pet waste bag of claim 1, wherein the fastener is a twist tie.

18-20. (canceled)

21. The pet waste bag of claim 1, wherein the fastener is or comprises a wire.

22-24. (canceled)

25. The pet waste bag of claim 1, wherein the fastener is connected to the body portion at a site that is less than 60% of the distance from the open end to the closed end.

26-41. (canceled)

42. The pet waste bag of claim 2, wherein, when the fastener is peeled off of the body portion, the fastener remains connected to the body portion by the adhesive or by the adhesive tape.

43. The pet waste bag of claim 2, wherein the fastener is at least 1 inch in length.

44. (canceled)

45. The pet waste bag of claim 2, wherein the fastener comprises a portion that is directly fixed to the body portion by the adhesive or the adhesive tape and a portion that is not directly fixed to the body portion by the adhesive or the adhesive tape.

46-48. (canceled)

49. The pet waste bag of claim 2, wherein, when the portion of the fastener that is not directly fixed to the body portion by the adhesive or the adhesive tape is peeled off the body portion, the portion of the fastener that is directly fixed to the body portion by the adhesive or the adhesive tape remains connected to the body portion by the adhesive or by the adhesive tape.

50. The pet waste bag of claim 2, further comprising a gripping texture.

51. A pet waste bag, comprising:
a body portion comprising an open end and a closed end; and
a gripping texture.

52. The pet waste bag of claim 51, further comprising a fastener.

53. The pet waste bag of claim 51, wherein the gripping texture comprises a raised texture.

54-64. (canceled)

65. The pet waste bag of claim 51, wherein the gripping texture is located 1 inch or less from the open end.

66-77. (canceled)

78. A package of pet waste bags, comprising two or more of the pet waste bags of claim 1.

79-82. (canceled)

83. A pet waste collection kit, comprising:
a pet waste bag of claim 1; and
a pet waste scooping device.

84. (canceled)

85. A pet waste collection kit, comprising:
a package of pet waste bags of claim 78; and
a pet waste scooping device.

86. (canceled)

87. A method of manufacturing a pet waste bag, comprising:
obtaining a body portion comprising an open end and a closed end; and
connecting a fastener to the body portion; and/or
applying a gripping texture to the body portion.

88-100. (canceled)

101. A method of using a pet waste bag, comprising:
obtaining a pet waste bag of claim 1;
securing pet waste inside of the pet waste bag; and
sealing the pet waste bag closed using the fastener.

102-106. (canceled)

107. A method of using a pet waste bag, comprising:
obtaining a pet waste bag of claim 1;
peeling open the open end of the pet waste bag using the gripping texture;
securing pet waste inside of the pet waste bag; and
closing the pet waste bag.
